(19) United States
(12) Patent Application Publication
(10) Pub. No.: US 2010/0311035 A1
(43) Pub. Date: Dec. 9, 2010

(54) Preservation solution for organs and biological tissues

(76) Inventors: Ben O'Mar Arrington, East Stroudsburg, PA (US); Maximillian Polyak, Gainesville, FL (US)

Correspondence Address: BLANK ROME LLP, WATERGATE, 600 NEW HAMPSHIRE AVENUE, N.W., WASHINGTON, DC, 20037, US

(21) Appl. No.: 11/921,055

(22) PCT Filed: May 26, 2006
(86) PCT No.: PCT/US06/20245

§ 371 Date: Mar. 5, 2010

Related U.S. Application Data
(60) Provisional application No. 60/684,515, filed on May 26, 2005.

(51) Int. Cl. A01N 1/02

(52) U.S. Cl. 435/1.2; 435/1.1

(57) ABSTRACT

The invention relates to the field of organ and biological tissue preservation. In particular, the invention relates to machine perfusion or cold storage solutions for the preservation of organs and biological tissues for implant and/or transplant. The preservation solution includes a prostaglandin having vasodilatory, membrane stabilizing, platelet aggregation prevention upon reperfusion, and complement activation inhibitory properties, a nitric oxide donor, a glutathione-forming agent, L-arginine, and ÿ-ketoglutarate.

### FIELD OF INVENTION

The invention relates to the field of organ and biological tissue preservation. In particular, the invention relates to machine perfusion or cold storage solutions for the preservation of organs and biological tissues for implant and/or transplant.

### BACKGROUND OF INVENTION

It is believed that the ability to preserve human organs for a few days by cold storage after initial flushing with an intracellular electrolyte solution or by pulsatile perfusion with an electrolyte-protein solution has allowed sufficient time for histo-compatibility testing of donor and recipient. It is also believed that preservation by solution or perfusion has also allowed for organ sharing among transplant centers, careful preoperative preparation of the recipient, time for preliminary donor culture results to become available, and vascular repairs of the organ prior to implantation.

It is believed that the 1990's has been a decade characterized by increasing waiting times for cadaveric organs. In renal transplantation, the growing disparity between available donors and patients on the waiting list has stimulated efforts to maximize utilization of cadaveric organs. An obstacle that may arise in the effort to increase utilization is that maximal utilization may require transplantation of all available organs, including extended criteria donor organs. However, by extending the criteria for suitability of donor organs, transplant clinicians may risk a penalty with respect to graft function, diminishing the efficiency of organ utilization if transplanted organs exhibit inferior graft survival. Consequently, interventions that both improve graft function and improve the ability of clinicians to assess the donor organ may be crucial to achieving the goal of maximizing the efficiency of cadaveric transplantation.

The mechanisms of injuries sustained by the cadaveric renal allograft during pre-preservation, cold ischemic preservation and reperfusion are believed to be complex and not fully understood. However, it is believed that there exists ample evidence to suggest that many of the injurious mechanisms occur as a result of the combination of prolonged cold ischemia and reperfusion (I/R). Reperfusion alone may not be deleterious to the graft, since reperfusion after short periods of cold ischemia may be well-tolerated, but reperfusion may be necessary for the manifestation of injuries that originate during deep and prolonged hypothermia. It is suggested that four major components of I/R injury that affect the preserved renal allograft begin during cold ischemia and are expressed during reperfusion. These include endothelial injury, leukocyte sequestration, platelet adhesion and increased coagulation.

Hypothermically-induced injury to the endothelium during preservation may lead to drastic alterations in cytoskeletal and organelle structures. During ischemic stress, profound changes in endothelial cell calcium metabolism may occur. These changes may be marked by the release of calcium from intracellular depots and by the pathological influx of calcium through the plasma membrane. Hypothermic preservation may disrupt the membrane electrical potential gradient, resulting in ion redistribution and uncontrolled circulation of Ca⁺⁺. The depletion of ATP stored during PR may compromise ATP-dependent pumps that extrude Ca⁺⁺ from the cell and the energy intensive shuttle of organelle membranes, causing a dramatic elevation of intracellular free Ca⁺⁺.

Alterations in cytosolic Ca⁺⁺ concentration may disrupt several intracellular functions, many of which may result in damaging effects. Unregulated calcium homeostasis has been implicated in the development of endothelial and parenchymal injury and is believed to be a fundamental step in the sequelae of steps leading to lethal cell injury. Among the most significant damaging effects of increased cytosolic Ca⁺⁺ are believed to be the activation of phospholipase A1, 2 and C; the cytotoxic production of reactive oxygen species by macrophages; the activation of proteases that enhance the conversion of xanthine dehydrogenase to xanthine oxidase; and mitochondrial derangements.

Solutions for preserving organs are described in U.S. Pat. Nos. 4,798,824 and 4,879,283, the disclosures of which are incorporated herein in their entirety. Despite such solutions, it is believed that there remains a need for organ and tissue preserving solutions that allow for static storage and preservation, while demonstrating superior quality preservation of organ and tissue viability and function.

### SUMMARY OF THE INVENTION

An object of the present invention is to provide an organ and tissue preservation solution for machine perfusion or cold storage that demonstrates superior quality preservation when compared to existing preserving media, in terms of organ and tissue viability and function. The organ and biological tissue preservation aqueous machine perfusion solution includes a prostaglandin having vasodilatory, membrane stabilizing, platelet aggregation prevention upon repdfusion, and complement activation inhibitory properties, a nitric oxide donor, a glutathione-forming agent, L-arginine, and α-ketoglutarate.

A further object of the present invention is to provide a preserved organ and biological tissue. The preserved organ and biological tissue includes a cadaveric organ or tissue within the present solution in a deep hypothermic condition or a physiological condition.

A further object of the present invention is to provide a perfusion machine comprising a chamber that mimics a deep hypothermic environment or physiological environment, where the machine perfusion solution continuously circulates through the chamber.

A further object of the present invention is to provide a method for preserving an organ or biological tissue. The method includes pouring the preservation solution into a chamber that mimics a deep hypothermic environment or physiological environment, circulating the preservation solution continuously through the chamber, inserting a cadaveric organ or tissue into the chamber, and flushing the cadaveric organ or tissue with the preservation solution.

Alternatively, the method flushes a cadaveric organ or tissue with the preservation solution of the invention, allows the flushed cadaveric organ or tissue to be enveloped in the solution, and then stores the cadaveric organ or tissue in the solution in a deep hypothermic condition or physiological condition.

A further object of the present invention is to provide a method of preparing a preservation solution. The method includes providing a solution with distilled water or deionized water; and mixing prostaglandin E1, nitroglycerin, N-acetylcysteine, L-arginine, and α-ketoglutarate into the solution.

### BRIEF DESCRIPTION OF THE DRAWINGS

FIG. 1 is a graph showing the results of the solutions of Table 1.

FIG. 2 is a graph showing the results of the solutions of Table 2.

### DETAILED DESCRIPTION OF THE PREFERRED EMBODIMENTS

In accordance with the present invention, the organ and biological tissue preservation solution includes a prostaglandin having vasodilatory, membrane stabilizing, platelet aggregation prevention upon reperfusion, and complement activation inhibitory properties, a nitric oxide donor, and a glutathione-forming agent. The organ and biological tissue preservation solution is intended for infusion into the vasculature of cadaveric and living donor organs for transplantation. Once infused, the donor organs are exsanguinated and blood is replaced by the solution in the native vasculature of the organs to return the organs to a normothermic condition. The solution may be used under deep hypothermic conditions or physiological conditions. The solution remains in the vasculature of the organ as well as envelops the entire organ during the period of cold ischemia. This method of preservation allows for the extended storage of organs, tissues, and all biological substances. When the organ or tissue is returned to normothermic conditions, the solution is replaced with blood or other physiologic media. Variations of this solution may also be used for cold storage solution preservation. The preservation solution of the invention may be used in the same manner and for the same tissues and organs as known machine perfusion solutions or known cold storage solutions.

The preservation solution of the invention includes a prostaglandin having vasodilatory, membrane stabilizing, platelet aggregation prevention upon reperfusion, and complement activation inhibitory properties. One such prostaglandin is Prostaglandin E1 (PGE1). PGE1 is an endogenous eicosanoid of the cyclooxygenase pathway and is utilized for its potent vasodilatory properties. In addition, PGE1 has cellular and organelle membrane stabilization properties, cryoprotective properties, and ability to prevent platelet aggregation upon the vascular endothelium post transplant. As such, PGE1 may inhibit neutrophil adhesion, inhibit neutrophil production of oxygen free radical species, counteract procoagulant activity after endothelial injury, and stabilize cell membranes. When used in vivo, PGE1 is metabolized almost instantaneously by first pass clearance through the lung, but during hypothermic conditions, PGE1 in the preservation solution may remain vasoactive even after several hours. PGE1 is preferably present at about 100-10,000 μg/L, more preferably about 100-5000 μg/L, and most preferably about 1000 μg/L.

The preservation solution of the invention also contains a nitric oxide donor, such as nitroglycerin. Nitroglycerin is utilized in the solution because of its potent nitric oxide donation properties, its ability to dilate the venous vascular system and prevent vasospasm, and its ability to prevent complement activation upon transplant. Nitroglycerin is known to relax smooth muscle cells of the endothelium, scavenge free oxygen radicals during reperfusion, and prevent the production of such radicals during cold ischemia. Nitroglycerin is preferably present at about 0.1 to 100 mg/L, more preferably about 1-50 mg/L, and most preferably about 10 mg/L.

Compounds that form glutathione (glutathione-forming agents) are also components of a machine perfusion solution of the invention. One such compound is N-acetylcystein. Glutathione (GSH) is synthesized from L-glutamate, L-cysteine, and glycine in 2 ATP-dependent reactions. The first reaction, known as catalyzed by gamma-glutamylcysteine synthetase, is effectively rate-limited by GSH feedback. The second involves GSH synthetase, which is not subject to feedback by GSH. When GSH is consumed and feedback inhibition is lost, availability of cysteine as a precursor becomes the rate-limiting factor. As such, N-acetylcysteine is proposed to be the only glutathione precursor that can enter the cell freely. In addition, the constitutive glutathione-building properties of N-acetylcysteine help prevent the formation of free oxygen radicals generated during the preservation period and during reperfusion with a recipient's blood. N-acetylcysteine is preferably present at about 0.02-20 mg/L, more preferably about 0.1-10 mg/L, and most preferably about 0.2 mg/L.

In a preferred embodiment, the preservation solution of the present invention also contains L-arginine. In the preservation solution, L-arginine enhances nitric oxide production, by serving as a substrate for endogenous nitric oxide synthase. The L-arginine is preferably present at about 0.1-10 g/L, more preferably about 0.5-5 g/L, and most preferably about 1 g/L.

The preservation also preferably contains α-ketoglutarate. Mitochondrial dysfunction and injury is a central factor leading to cell death in ischemia/reperfusion injury. Cellular energy deficit after reperfusion can ultimately lead activation of phospholipases, disruption of lysosomal membranes, calcium influx, and cell death. α-Ketoglutarate, a Krebs cycle intermediate, augments mitochondrial energy balance in kidney proximal tubule cells. Addition of α-ketoglutarate to cardiopelgia solution also protects myocardium from reperfusion injury during open heart operations. α-ketoglutarate is preferably present at about 0.2-20 mg/L, ore preferably about 1-10 mg/L, and most preferably about 2 mg/L.

According to a preferred embodiment of the invention, an organ and biological tissue preservation cold storage solution containing PGE1, nitroglycerin, and N-acetylcysteine in the preserving solution significantly improves vascular resistance, vascular flow, and calcium efflux during the organ preservation period. The inhibition of calcium efflux over time in kidneys preserved by the proposed solution suggests that, in addition to vasoactive effects, an additional cytoprotective and cryoprotective effect may also be important in ameliorating ischemic injury. These improvements are substantiated ultrastructurally by improved appearance of mitochondria in proximal tubular cells compared to mitochondria from kidneys not exposed to the proposed solution.

A preservation solution of the invention may also contain components typically used in known machine perfusion solutions. See, U.S. Pat. Nos. 4,798,824 and 4,879,283. For example, other components that may be utilized in the solution include: sodium gluconate and Mg gluconate, which are impermeant anions that reduce cell swelling, KH₂PO₄, which provides acid-base buffering and maintains the pH of the solution, adenine, which is a precursor to ATP synthesis, and ribose, which reduces cell swelling during hypothermia. In addition, CaCl₂, which is a calcium-dependent mitochondrial function supplement, HEPES, which is an acid-base buffer, glucose, which is a simple sugar that reduces cell swelling and provides energy stores for metabolically stressed cell, and mannitol and pentastarch, which are oncotic supporters, may also be added. NaCl and KOH may also be used for acid-base buffering and maintenance of the pH of the machine perfusion solution.

In a preferred embodiment, the preservation solution for machine perfusion includes, but is not limited to, about 40-160 mM sodium gluconate, about 10-50 mM KH₂PO₄, about 1-15 mM Mg gluconate, about 1-15 mM adenine, about 1-15 mM ribose, about 0.1-2 mM CaCl₂, about 1-30 mM HEPES, about 1-30 mM glucose, about 10-100 mM mannitol, about 40-60 g/L pentastarch, about 100-10,000 μg/L prostaglandin E1, about 0.1-100 mg/L nitroglycerin, about 0.2-20 mg/L N-acetylcystein, about 0.1-10 g/L L-arginine, and about 0.2-20 mg/L α-ketoglutarate.

In a more preferred embodiment, the preservation solution for machine perfusion includes, but is not limited to, about 60-100 mM sodium gluconate, about 20-30 mM KH₂PO₄, about 3-8 mM Mg gluconate, about 3-8 mM adenine, about 3-8 mM ribose, about 0.3-0.8 mM CaCl₂, about 8-15 mM HEPES, about 8-15 mM glucose, about 15-50 mM mannitol, about 45-55 g/L pentastarch, about 100-5000 μg/L prostaglandin E1, about 1-50 g/L nitroglycerin, about 0.1-10 mg/L N-acetylcystein, about 0.5-5 g/L L-arginine, and about 1-10 mg/L α-ketoglutarate.

In a most preferred embodiment, the preservation solution for machine perfusion includes, but is not limited to, about 80 mM sodium gluconate, about 25 mM KH₂PO₄, about 5 mM Mg gluconate, about 5 mM adenine, about 5 mM Ribose, about 0.15 mM CaCl₂, about 10 mM HEPES, about 10 mM glucose, about 30 mM mannitol, about 50 g/L pentastarch, about 1000 μg/L prostaglandin E1, about 10 mg/L nitroglycerin, about 0.2 mg/L N-acetylcystein, about 1 g/L L-arginine, and about 2 mg/L α-ketoglutarate.

In a preferred embodiment, the preservation solution for cold storage includes, but is not limited to, about 50-150 mM potassium lactobionate, about 10-40 mM KH₂PO₄, about 2-8 mM MgSO₄, about 10-50 mM raffinose, about 1-20 mM adenosine, about 1-10 mM allopurinol, about 40-60 g/L pentastarch, about 100-10,000 μg/L prostaglandin E1, about 0.1-100 mg/L nitroglycerin, about 0.2-20 mg/N-acetylcystein, about 0.1-10 g/L L-arginine, and about 0.2-20 mg/L α-ketoglutarate.

In a more preferred embodiment, the preservation solution for cold storage includes, but is not limited to, about 75-125 mM potassium lactobionate, about 20-30 mM KH₂PO₄, about 3-7 mM MgSO₄, about 20-40 mM raffinose, about 2-10 mM adenosine, about 1-5 mM allopurinol, about 45-55 g/L pentastarch, about 100-5000 μg/L prostaglandin E1, about 1-50 g/L nitroglycerin, about 0.1-10 mg/L N-acetylcystein, about 0.5-5 g/L L-arginine, and about 1-10 mg/L α-ketoglutarate.

In a most preferred embodiment, the preservation solution for cold storage includes, but is not limited to, about 100 mM potassium lactobionate, about 25 mM KH₂PO₄, about 5 mM MgSO₄, about 30 mM raffinose, about 5 mM adenosine, about 1 mM allopurinol, about 50 g/L pentastarch, about 1000 μg/L prostaglandin E1, about 10 mg/L nitroglycerin, about 0.2 mg/L N-acetylcystein, about 1 g/L L-arginine, and about 2 mg/L α-ketoglutarate.

A preservation solution of the invention may be prepared by combining the components described above with sterile water, such as distilled and/or deionized water. Methods of making a desired solution given the desired concentration of the components are within the ability of those skilled in the art.

The invention also provides a method for preserving an organ or biological tissue. The method includes pouring the machine perfusion solution into a chamber that mimics a deep hypothermic environment or physiological environment and moving the machine perfusion solution continuously through the chamber. The machine perfusion solution is infused in a mechanical fashion through the arterial or venous vascular system of cadaveric or living donor organs, or infused over or through an a vascular biological substance in order to maintain organ or tissue viability during the ex vivo period. Preferred temperatures range from about 2-10° C. in the deep hypotheitnic condition and are about 37° C., or room temperature, in the physiological condition. Use of this solution provides for the serial assay of solution over time to determine hydrostatic and chemical changes. These hydrostatic and chemical changes provide a mechanism to determine the functional viability of the organ or tissue once it has been returned to physiologic conditions.

Alternatively, the method flushes a cadaveric organ or tissue with a cold storage solution of the invention, allows the flushed cadaveric organ or tissue to be enveloped in the cold storage solution, and then stores the cadaveric organ or tissue in the cold storage solution in a deep hypothermic condition or physiological condition. Additional cold storage solution may be added to ensure adequate preservation of the organ or tissue. Preferred temperatures range from about 2-10° C. in the deep hypothermic condition and are about 37° C., or room temperature, in the physiological condition. In one embodiment, the cold storage solution is first cooled to below 10° C. using an ice bath or other cooling means known in the art. It is typical to inspect the cooled solution for any precipitates which may be removed by filtration prior to use. Alternatively, the organ or tissue to be preserved may be placed in the solution and then cooled.

The invention further provides a perfusion machine comprising a chamber that mimics a deep hypothermic environment or physiological environment, where the machine perfusion solution continuously moves through the chamber. Any perfusion machine that is known in the art may be used with the solution, including machines providing pulsatile, low flow, high flow, and roller flow perfusion. Typically, the perfusion machine includes a unit for the static monitoring or transportation of organs or biological tissues and a cassette, or chamber, used to circulate perfusate through the organs or biological tissues. A monitor displays pulse pump rate, perfusate temperature, systolic, mean, and diastolic pressure, and real-time flow. Once such machine is the RM3 Renal Preservation System® manufactured by Waters Instruments, Inc. As discussed above, preferred temperatures range from about 2-10° C. in the deep hypothermic condition and are about 37° C., or room temperature, in the physiological condition.

Without further description, it is believed that one of ordinary skill in the art can, using the preceding description and the following illustrative examples, make and utilize the compounds of the present invention and practice the claimed methods. The following examples are given to illustrate the present invention. It should be understood that the invention is not to be limited to the specific conditions or details described in these examples.

### Example 1

### Cold Storage Solution

Sprague-Dawley rat kidneys were recovered in the normal fashion and were exsanguinated and cooled to 4° C. Experimental components were added to the solution to test for improvements in post-transplant function (indicated by serum creatinine levels). Seven different solutions were prepared for comparison according to Table 1. According to Table 1, the control VIASP solution contains only Viaspan solution; the PEG solution contains Viaspan and 1000 μg/L prostaglandin E1; the NTG solution contains Viaspan and 10 mg/L nitroglycerin; the NAC solution contains Viaspan and 0.2 mg/L N-acetylcystein; the LA solution contains Viaspan and 1 g/L L-arginine; the AKG solution contains Viaspan and 2 mg/L α-ketoglutarate; and the COMB solution contains Viaspan, 1000 μg/L prostaglandin E1, 10 mg/L nitroglycerin, and 0.2 mg/L N-acetylcystein. The kidneys were preserved under static conditions for 24 hours with the respective solutions, and transplanted into recipient animals. Post-transplant serum creatinine (S. CREAT) was measured hourly for 6 hours.

TABLE 1

| | VIASP | PGE | NTG | NAC | LA | AKG | COMB |
|---|---|---|---|---|---|---|---|
| Viaspan | + | + | + | + | − | − | + |
| Prostaglandin | − | + | − | − | − | − | + |
| E1 (1000 μg/L) | | | | | | | |
| Nitroglycerin | − | − | + | − | − | − | + |
| (10 mg/L) | | | | | | | |
| N- | − | − | − | + | − | − | + |
| Acetylcystein | | | | | | | |
| (0.2 mg/L) | | | | | | | |
| L-Arginine | − | − | − | − | + | − | + |
| (1 g/L) | | | | | | | |
| α-ketoglutarate | − | − | − | − | − | + | + |
| (2 mg/L) | | | | | | | |

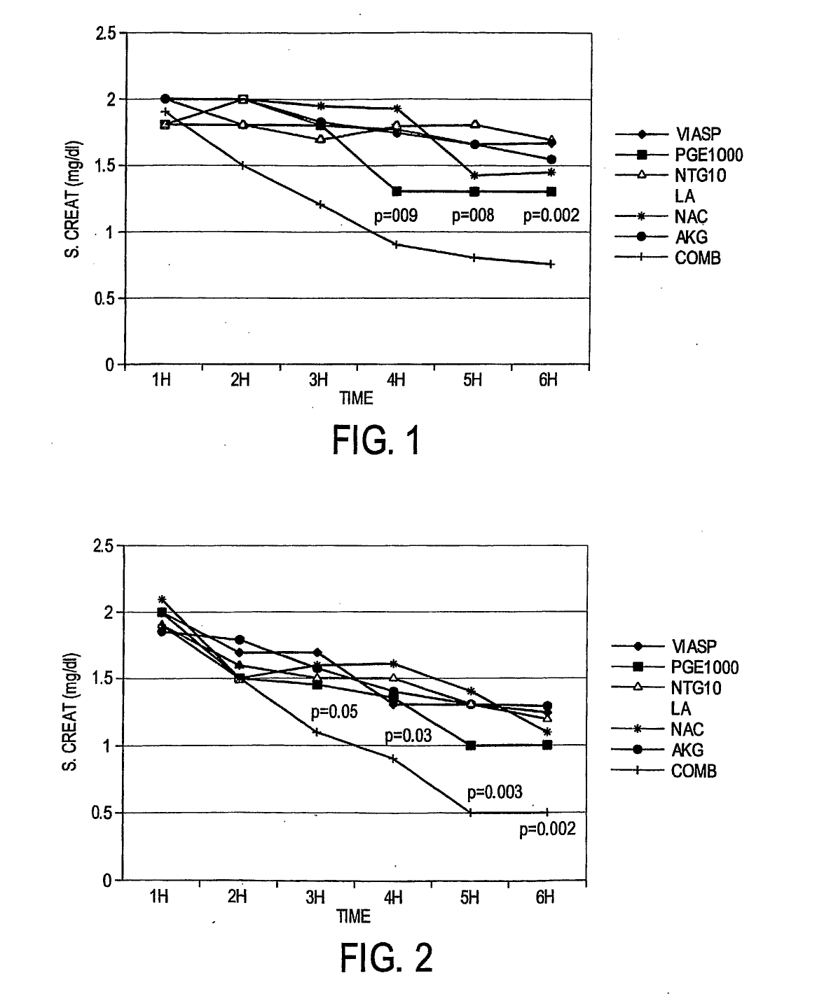

The result is depicted in FIG. 1. Minimal, but statistically insignificant improvements in post-transplant function were observed with prostaglandin E1, nitroglycerin, N-acetylcystein, L-arginine, or α-ketoglutarate individually when compared to the control. From this observation, one of ordinary skill in the art would not have expected significant improvement when prostaglandin E1, nitroglycerin, N-acetylcystein, L-arginine, and α-ketoglutarate are used together (the COMB solution). However, dramatic improvement was observed on post-transplant function of the COMB solution when compared to the control. Because no one individual component demonstrated a substantial improvement compared to the control, a synergistic improvement when all components were added is not expected.

### Example 2

### Machine Perfusion Solution

Rat kidneys were recovered as above. Seven different solutions were prepared for comparison according to Table 2. According to Table 2, the control BELZ solution contains only Belzer solution; the PEG solution contains Belzer and 1000 μg/L prostaglandin E1; the NTG solution contains Belzer and 10 mg/L nitroglycerin; the NAC solution contains Belzer and 0.2 mg/L N-acetylcystein; the LA solution contains Belzer and 1 g/L L-arginine; the AKG solution contains Belzer and 2 mg/L α-ketoglutarate; and the COMB solution contains Belzer, 1000 μg/L prostaglandin E1, 10 mg/L nitroglycerin, and 0.2 mg/L N-acetylcystein. The kidneys were preserved under machine perfusion for 24 hours with the respective solutions, and transplanted into recipient animals. Post-transplant serum creatinine (S. CREAT) was measured hourly for 6 hours.

TABLE 2

| | BELZ | PGE | NTG | NAC | LA | AKG | COMB |
|---|---|---|---|---|---|---|---|
| Belzer | + | + | + | + | − | − | + |
| Prostaglandin | − | + | − | − | − | − | + |
| E1 (1000 μg/L) | | | | | | | |
| Nitroglycerin | − | − | + | − | − | − | + |
| (10 mg/L) | | | | | | | |
| N- | − | − | − | + | − | − | + |
| Acetylcystein | | | | | | | |
| (0.2 mg/L) | | | | | | | |
| L-Arginine | − | − | − | − | + | − | + |
| (1 g/L) | | | | | | | |
| α-ketoglutarate | − | − | − | − | − | + | + |
| (2 mg/L) | | | | | | | |

The result is depicted in FIG. 2, and is similar to Example 1. Minimal, but statistically insignificant improvements in post-transplant function were observed with prostaglandin E1, nitroglycerin, N-acetylcystein, L-arginine, or α-ketoglutarate individually when compared to the control. From this observation, one of ordinary skill in the art would not have expected significant improvement when prostaglandin E1, nitroglycerin, N-acetylcystein, L-arginine, and α-ketoglutarate are used together (the COMB solution). However, dramatic improvement was observed on post-transplant function of the COMB solution when compared to the control. Because no one individual component demonstrated a substantial improvement compared to the control, a synergistic improvement when all components were added is not expected.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A preservation solution for machine perfusion or cold storage of an organ or a biological tissue comprising
a prostaglandin having vasodilatory, membrane stabilizing, platelet aggregation prevention upon reperfusion, and complement activation inhibitory properties;
a nitric oxide donor;
a glutathione-forming agent;
L-arginine; and
α-ketoglutarate.

2. The preservation solution of claim 1, wherein the prostaglandin is prostaglandin E1.

3. The preservation solution of claim 2, wherein the prostaglandin E1 is present at about 100-10,000 μg/L.

4. The preservation solution of claim 1, wherein the nitric oxide donor is nitroglycerin.

5. The preservation solution of claim 4, wherein the nitroglycerin is present at about 0.1 to 100 mg/L.

6. The preservation solution of claim 1, wherein the glutathione-forming agent is N-acetylcystein.

7. The preservation solution of claim 6, wherein the N-acetylcystein is present at about 0.02-20 mg/L.

8. The preservation solution of claim 1, wherein the L-arginine is present at about 0.1-10 g/L.

9. The preservation solution of claim 1, wherein the α-ketoglutarate is present at about 0.2-20 mg/L.

10. A method for preserving an organ or biological tissue comprising the steps of
providing the preservation solution of claim 1;
pouring the preservation solution into a chamber that mimics a deep hypothermic environment or physiological environment;
circulating the preservation solution continuously through the chamber;
inserting the organ or biological tissue into the chamber; and
flushing the organ or biological tissue with the preservation solution.

11. The method of claim 10, wherein the prostaglandin is prostaglandin E1.

12. The method of claim 11, wherein the prostaglandin E1 is present at about 100-10,000 μg/L.

13. The method of claim 10, wherein the nitric oxide donor is nitroglycerin.

14. The method of claim 13, wherein the nitroglycerin is present at about 0.1 to 100 mg/L.

15. The method of claim 10, wherein the glutathione-forming agent is N-acetylcystein.

16. The method of claim 15, wherein the N-acetylcystein is present at about 0.02-20 mg/L.

17. The method of claim 10, wherein the L-arginine is present at about 0.1-10 g/L.

18. The method of claim 10, wherein the α-ketoglutarate is present at about 0.2-20 mg/L.

19. A method for preserving an organ or biological tissue comprising the steps of
providing the preservation solution of claim 1;
flushing the organ or biological tissue with the preservation solution;
allowing the flushed organ or biological tissue to be enveloped in the preservation solution; and
storing the organ or biological tissue in the solution in a deep hypothermic condition or physiological condition.

20. The method of claim 19, wherein the prostaglandin is prostaglandin E1.

21. The method of claim 20, wherein the prostaglandin E1 is present at about 100-10,000 μg/L.

22. The method of claim 19, wherein the nitric oxide donor is nitroglycerin.

23. The method of claim 22, wherein the nitroglycerin is present at about 0.1 to 100 mg/L.

24. The method of claim 19, wherein the glutathione-forming agent is N-acetylcystein.

25. The method of claim 24, wherein the N-acetylcystein is present at about 0.02-20 mg/L.

26. The method of claim 19, wherein the L-arginine is present at about 0.1-10 g/L.

27. The method of claim 19, wherein the α-ketoglutarate is present at about 0.2-20 mg/L.
